(19) United States
(12) Patent Application Publication
(10) Pub. No.: US 2022/0188903 A1
(43) Pub. Date: Jun. 16, 2022

(54) Systems And Methods For Ordering Goods And Services Using A Vehicle

(71) Applicant: Ford Global Technologies, LLC, Dearborn, MI (US)

(72) Inventors: Sathyanarayana Chary Palakonda, Northville, MI (US); Allen R. Murray, Lake Orion, MI (US); Joe Stanek, Northville, MI (US); Thomas Varghese, Farmington Hills, MI (US); Asma Yousuf, Farmington Hills, MI (US)

(73) Assignee: Ford Global Technologies, LLC, Dearborn, MI (US)

(21) Appl. No.: 17/121,981

(22) Filed: Dec. 15, 2020

(51) Int. Cl. G06Q 30/06; G06Q 10/08; G06Q 30/02

(52) U.S. Cl. CPC G06Q 30/0633; G06Q 30/0265; G06Q 10/083

(57) ABSTRACT

The disclosure provides systems and methods for ordering goods and services using a vehicle and for delivering the goods and services to the vehicle.

### BACKGROUND

Ordering and delivery processes can be time consuming. For example, a customer may have a long wait time to receive delivery of an item even if an order is place online. Or a customer may be required to perform a series of tasks to receive delivery of goods and services even if an order is place online. It is with respect to these and other considerations that the disclosure made herein is presented.

### DESCRIPTION OF THE FIGURES

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a schematic illustration of a system for ordering goods and services using a vehicle in accordance with the present disclosure.

FIG. 2 is a schematic illustration of a method for ordering goods and services using a vehicle in accordance with the present disclosure.

FIG. 3 is a schematic illustration of vehicle systems in accordance with the present disclosure.

### DETAILED DESCRIPTION

### Overview

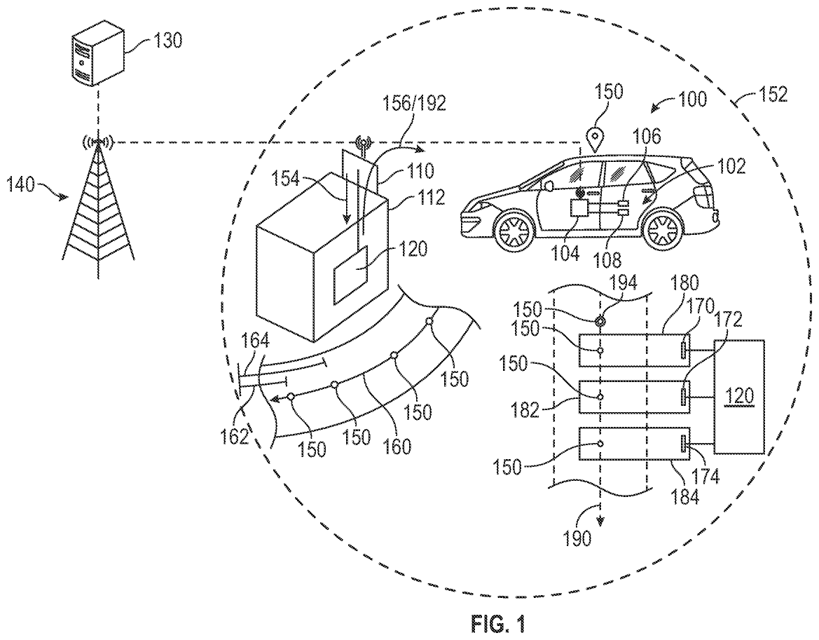

The disclosure provides systems and methods for ordering goods and services using a vehicle and delivering the goods and services to the vehicle. Referring to FIG. 1, the systems and methods provide a vehicle 100 that includes a vehicle control unit 102 (VCU). The VCU 102 includes a telematics control unit 104 (TCU), a human machine interface 106 (HMI), and a memory 108. The TCU 104 is configured to communicate with a road-side unit 110 (RSU), for example, using vehicle-to-everything (V2X) systems and methods.

The RSU 110 is located at or incorporated into the infrastructure of a business structure 112 and is connected to a business computer 120 of the business structure 112. For example, the business structure 112 may be that of a fast-food restaurant, grocery store, car wash, or any other suitable business or service. The systems and methods described herein are applicable to any suitable business.

The RSU 110 is configured to communicate with a credit server 130, for example, using cellular communication systems and methods. The RSU 110 may communicate with the credit server 130 using a cellular tower 140. Any suitable communication protocols may be used herein.

The HMI 106 is configured to generate an order or a list of selected goods and services. The HMI 106 may include a touchscreen and/or a voice command interface.

The TCU 104 and the RSU 110 are configured to communicate with one another to authenticate the vehicle 100 to confirm the order, to communicate with the credit server 130 to complete a transaction for the order, and to communicate with the business computer 120 to facilitate delivering the goods and services listed in the order.

The RSU 110 and/or the TCU 104 determines a vehicle location 150 of the vehicle 100. The RSU 110 may determine when the vehicle location 150 of the vehicle 100 is in a geozone 152 defined by the RSU 110. If the vehicle location 150 is in the geozone 152, the RSU 110 may send an alert message 154 (AM) to the business computer 120. The alert message 154 may notify the business computer 120 to prepare the order (e.g., in the case of a fast-food restaurant, grocery store, or the like) and/or to bring the order out to the vehicle 100. The business computer 120 may generate a status message 156 (SM) and send the status message 156 to the HMI 106 of the vehicle 100 to confirm that the alert message 154 has been received and to notify the vehicle 100 of the status of the order. The RSU 110 and the TCU 104 may also transition to localized (e.g., PC5) communication channels.

The business computer 120 may determine a sequence in which to prepare the orders of multiple vehicles 100 (and/or to bring the orders out to the vehicles 100) based on the sequence in which alert messages 154 are received from different vehicles 100.

The TCU 104 and/or the RSU 110 may send the vehicle location 150 to the business computer 120. The business computer 120 may map the vehicle location 150 in cases where the goods or services are brought out to the vehicle 100 (e.g., curbside pick-up).

The business computers 120 may also use the vehicle locations 150 of multiple vehicles 100 to determine or confirm a sequence in which to prepare different orders based on the vehicle location 150 associated with each order. For example, an order for a vehicle location 150 that is closer (e.g., a first distance 162 to a pick-up window along a path 160 of a drive through) is prepared before an order for a vehicle location 150 that is further away (e.g., a second distance 164 to a pick-up window along the path 160 of the drive through).

The business computer 120 may use the vehicle location 150 of the vehicle 100 to coordinate the operation of systems that communicate with or are controlled by the business computer 120. In the case of a car wash, the vehicle location 150 may be used to start and stop systems 170, 172, 174 (e.g., jets, soap spray nozzles, wraps and matters, blowers, water, waxes, etc.) associated with different stages or zones 180, 182, 184 of a car wash as the vehicle location 150 moves along a path 190 (e.g., on a track) through the zones 180, 182, 184.

Inside the geozone 152, the business computer 120 may send a mode message 192 (MM) to instruct the VCU 102 to place systems of the vehicle 100 in a business-specific mode of operation. For example, the status message 156 may include the mode message 192.

The mode message 192 may be a notification or link displayed on the HMI 106 for the driver of a vehicle 100. By clicking the link or manually navigating to a mode set, a user may initiate a delivery mode for receiving delivery of goods or services once parked. The VCU 102 may control vehicle systems to implement the delivery mode, for example, by unlocking and/or opening a trunk space to receive goods.

The mode message 192 may also include a mode location 194 and/or directions to the mode location 194 that are displayed on the HMI 106. The mode location 194 may be a drive through window, lane, parking spot, or similar where the vehicle 100 is directed to receive delivery.

The mode location 194 may be at the beginning of a track (autonomous vehicle control may be used instead of track) or otherwise at the start of a car wash tunnel. The VCU 102 may implement a car wash mode (or alert the user to manually select the mode) when the vehicle location 150 matches the mode location 194. The car wash mode (operation set) may include retracting side mirrors, closing windows/sunroof and confirming closed, turning off windshield wipers, steering the vehicle or directing a driver onto the track, placing the vehicle in neutral, and the like. If the car wash mode is not confirmed or is not maintained (e.g., a car window is opened), the car wash may pause or cease operations.

The VCU 102 may provide the business computer 120 with other vehicle information (e.g., size, type) that may be used to customize the operation of the car wash systems or to verify that goods will fit in the vehicle 100. Customized operation may include customized spray angles and customized speed and spacing to optimize washing and drying for vehicles with different dimensions (e.g., sedans or trucks)

These and other advantages of the present disclosure are provided in greater detail herein.

### Illustrative Embodiments

The disclosure will be described more fully here in after with reference to the accompanying drawings, in which exemplary embodiments of the disclosure are shown, and not intended to be limiting. The disclosure provides systems and methods for ordering goods and/or services using a vehicle and delivering the goods and services to the vehicle.

Referring to FIG. 1, the systems and methods provide the vehicle 100 that includes the vehicle control unit 102 (VCU). The VCU 102 includes the telematics control unit 104 (TCU), the human machine interface 106 (HMI), and the memory 108.

The TCU 104 is configured to communicate with the road-side unit 110 (RSU), for example, using vehicle-to-everything (V2X) systems and methods. The RSU 110 is located at or incorporated into the infrastructure of the business structure 112 and is connected to the business computer 120 of the business. For example, the business may be a fast-food restaurant or a car wash.

The RSU 110 is configured to communicate with the credit server 130, for example, using cellular communication systems and methods. The RSU 110 may communicate with the credit server 130 via the cellular tower 140.

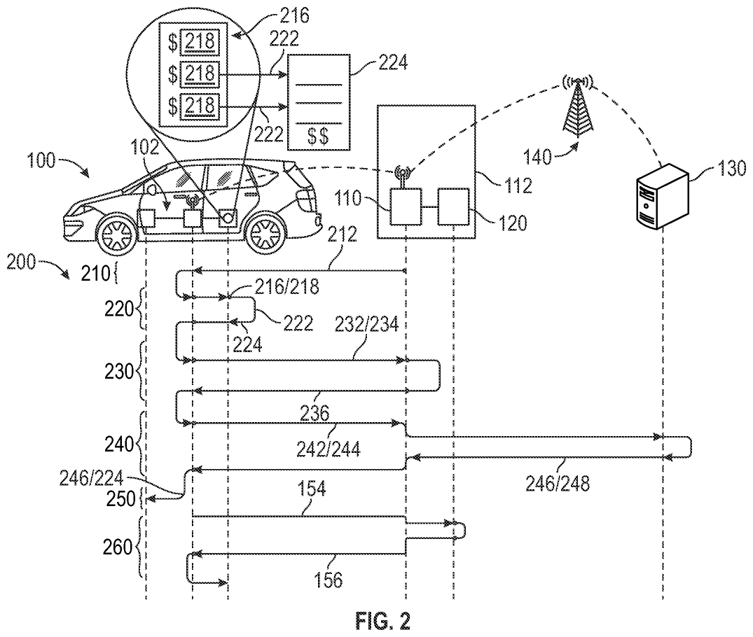

Referring to FIG. 2, an exemplary method 200 is described. According to a first step 210 of an exemplary method 200, the RSU 110 broadcasts (e.g., within a certain range of the business structure 112) an advertisement message 212 (AM) (e.g., including the location of the business, rates, etc.). The advertisement message 212 may include a link to a menu 216 of options 218 of goods and/or services. The TCU 104 may receive the advertisement message 212 and display the link on the HMI 106.

According to a second step 220, in response to selecting the link on the HMI 106 or otherwise accepting the advertisement message 212, the TCU 104 accesses and displays the menu 216 of options 218 on the HMI 106. A user in the vehicle 100 makes selections 222 through the HMI 106 to create a list of selections 222 (i.e., an order 224) from the menu 216 of options 218. The order 224 is submitted through the HMI 106.

In response, according to a third step 230, the TCU 104 communicates with the RSU 110 to authenticate the vehicle 100. The TCU 104 sends a request message 232 (RM) to the RSU 110. The request message 232 may include a vehicle identifier 234 for the vehicle 100. If the RSU 110 is able to authenticate the vehicle 100 with the vehicle identifier 234, the RSU 110 sends an acknowledgement message 236 (AM) to the TCU 104 to confirm the order 224.

If the order 224 is confirmed with the acknowledgement message 236, according to a fourth step 240, the TCU 104 generates a purchase message 242 (PM) for payment authorization by the credit server 130. The purchase message 242 may include a vehicle account 244 (e.g., payment method) associated with the vehicle identifier 234. The credit server 130 may determine the validity of the vehicle account 244 and/or whether the vehicle account 244 has sufficient credit to conduct the transaction.

The TCU 104 sends the purchase message 242 to the RSU 110. The RSU 110 verifies the security of the purchase message 242 and forwards the purchase message 242 to the credit server 130. The credit server 130 verifies the vehicle account 244 and authorizes payment or otherwise completes the transaction. The credit server 130 generates a receipt message 246 (RM), including a receipt ID 248, and sends the receipt message 246 to the RSU 110. The RSU 110 sends the receipt message 246 to the TCU 104.

According to a fifth step 250, the TCU 104 stores the receipt message 246 and the order 224 in the memory 108. Orders 224 or lists of selections 222 from previous transactions may be used as suggested or promoted options 218 on the menu 216.

According to a sixth step 260, the RSU 110 and/or the TCU 104 determines the vehicle location 150. Referring to FIG. 1, the RSU 110 may determine whether the vehicle location 150 is in the geozone 152 defined by the RSU 110. If the vehicle location 150 is in the geozone 152, the RSU 110 may send an alert message 154 (AM) to the business computer 120. The alert message 154 may notify the business computer 120 to prepare the order 224 (e.g., in the case of a fast-food restaurant) and/or to bring the order 224 out to the vehicle 100. The business computer 120 may generate a status message 156 (SM) and send the status message 156 to the HMI 106 of the vehicle 100 to confirm that the alert message 154 has been received and to notify the vehicle 100 of the status of the order 224.

The business computer 120 may determine a sequence in which to prepare the orders 224 of multiple vehicles 100 (and/or to bring the orders out to the vehicles 100) based on the sequence in which alert messages 154 are received from different vehicles 100.

The TCU 104 or the RSU 110 may send the vehicle location 150 to the business computer 120. The business computer 120 may map the vehicle location 150 in cases where the goods or services are brought out to the vehicle 100 (e.g., curbside pick-up).

Referring to FIG. 1, the business computers 120 may also use the vehicle locations 150 of multiple vehicles 100 to determine or confirm a sequence in which to prepare different orders 224 based on the vehicle location 150 associated with each order 224. For example, an order 224 for a vehicle location 150 that is closer (e.g., a first distance 162 to a pick-up window along a path 160 of a drive through) is prepared before an order 224 for a vehicle location 150 that is further away (e.g., a second distance 164 to a pick-up window along the path 160 of the drive through).

The business computer 120 may use the vehicle location 150 of the vehicle 100 to coordinate the operation of systems that communicate with or are controlled by the business computer 120. In the case of a car wash, the vehicle location 150 of the vehicle 100 may be used to start and stop systems 170, 172, 174 (e.g., jets, soap spray nozzles, wraps and matters, blowers, etc.) associated with different stages or zones 180, 182, 184 of a car wash as the vehicle location 150 moves along a path 190 (e.g., on a track) through the zones 180, 182, 184.

Inside the geozone 152, the business computer 120 may send a mode message 192 (MM) to instruct the TCU 104 to place the vehicle 100 in a business-specific mode. For example the status message 156 may include the mode message 192. The mode message 192 may be a notification or link displayed on the HMI 106 for the driver of a vehicle 100 to initiate a delivery mode for receiving delivery of goods or services once parked. The TCU 104 may implement the delivery mode, for example, by unlocking and/or opening a trunk space to receive goods.

The mode message 192 may also include a mode location 194 and/or directions to the mode location 194 that are displayed on the HMI 106. The TCU 104 may implement a car wash mode when the vehicle location 150 matches the mode location 194, for example, at the beginning of a track of a car wash tunnel. The car wash mode may include retracting side mirrors, closing windows/sunroof and confirming closed, turning off windshield wipers, steering the vehicle or directing a driver onto the track, placing the vehicle in neutral, and the like.

The TCU 104 may provide the business computer 120 with other vehicle information (e.g., size, type) that may be used to customize the operation of the car wash systems.

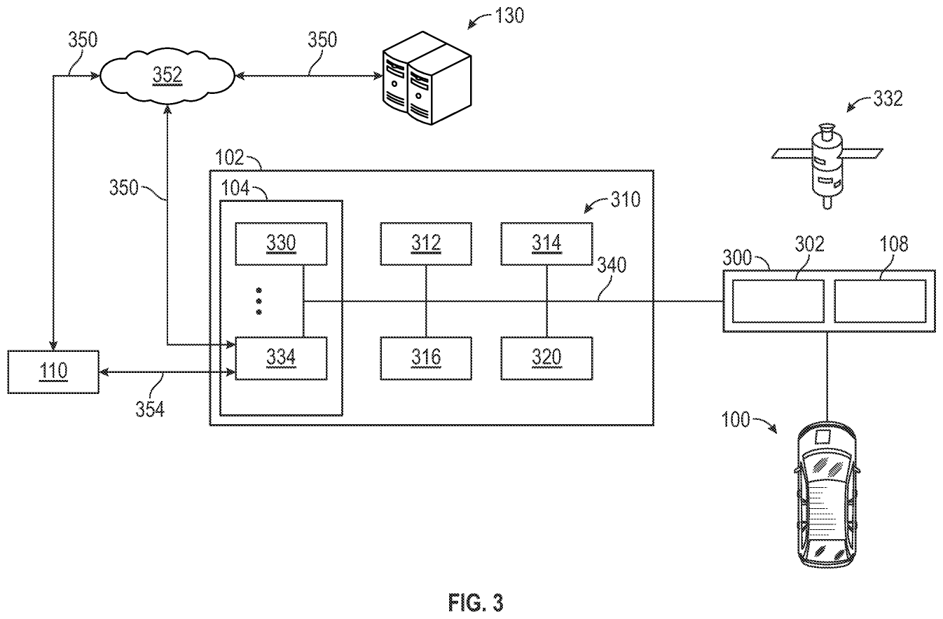

Referring to FIG. 3, systems are described in greater detail. An automotive computer 300, the RSU 110, and the business computer 120 includes computer components including a memory (e.g., memory 108) and a processor (e.g., a processor 302). A processor may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs).

A memory may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory includes multiple kinds of memory, particularly volatile memory and non-volatile memory.

Memory is computer readable media on which one or more sets of instructions, such as the software for performing the methods of the present disclosure, can be embedded. The instructions may embody one or more of the methods or logic as described herein. The instructions may reside completely, or at least partially, within any one or more of the memory, the computer readable medium, and/or within the processor during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

Continuing with FIG. 3, the VCU 102 includes a plurality of electronic control units (ECUs) 310 disposed in communication with the automotive computer 300. The VCU 102 may coordinate the data between vehicle systems, connected servers (e.g., the credit server 130), and other vehicles operating as part of a vehicle fleet. The VCU 102 may control aspects of the vehicle 100, and implement one or more instruction sets received from a vehicle system controller (such as automotive computer 300) and/or received from the RSU 110.

The VCU 102 can include or communicate with any combination of the ECUs 310, such as, for example, a Body Control Module (BCM) 312, an Engine Control Module (ECM) 314, a Transmission Control Module (TCM) 316, the Telematics Control Unit 104 (TCU), a Restraint Control Module (RCM) 320, and the like. The TCU 104 may be disposed in communication with the ECUs 310 by way of a Controller Area Network (CAN) bus 340. In some aspects, the TCU 104 may retrieve data and send data as a CAN bus 340 node.

The CAN bus 340 may be configured as a multi-master serial bus standard for connecting two or more of the ECUs 310 as nodes using a message-based protocol that can be configured and/or programmed to allow the ECUs 310 to communicate with each other. The CAN bus 340 may be or include a high-speed CAN (which may have bit speeds up to 1 Mb/s on CAN, 5 Mb/s on CAN Flexible Data Rate (CAN FD)), and can include a low-speed or fault tolerant CAN (up to 125 Kbps), which may, in some configurations, use a linear bus configuration. In some aspects, the ECUs 310 may communicate with a host computer (e.g., the automotive computer 300, the RSU 110, and/or server(s), etc.), and may also communicate with one another without the necessity of a host computer.

The CAN bus 340 may connect the ECUs 310 with the automotive computer 300 such that the automotive computer 300 may retrieve information from, send information to, and otherwise interact with the ECUs 310 to perform steps described according to embodiments of the present disclosure. The CAN bus 340 may connect CAN bus nodes (e.g., the ECUs 310) to each other through a two-wire bus, which may be a twisted pair having a nominal characteristic impedance. The CAN bus 340 may also be accomplished using other communication protocol solutions, such as Media Oriented Systems Transport (MOST) or Ethernet. In other aspects, the CAN bus 340 may be a wireless intra-vehicle CAN bus.

The VCU 102 may control various loads directly via the CAN bus 340 communication or implement such control in conjunction with the BCM 312. The ECUs 310 described with respect to the VCU 102 are provided for exemplary purposes only, and are not intended to be limiting or exclusive. Control and/or communication with other control modules is possible, and such control is contemplated.

The ECUs 310 may control aspects of vehicle operation and communication using inputs from human drivers, inputs from a vehicle system controller, and/or via wireless signal inputs received via wireless channel(s) from other connected devices. The ECUs 310, when configured as nodes in the CAN bus 340, may each include a central processing unit (CPU), a CAN controller, and/or a transceiver.

The TCU 104 can be configured to provide vehicle connectivity to wireless computing systems onboard and offboard the vehicle 100 and is configurable for wireless communication between the vehicle 100 and other systems, computers, servers, RSUs 110, and modules.

For example, the TCU 104 includes a Navigation (NAV) system 330 for receiving and processing a GPS signal from a GPS 332, a Bluetooth® Low-Energy Module (BLEM) 334, a Wi-Fi transceiver, an Ultra-Wide Band (UWB) transceiver, and/or other wireless transceivers described in further detail below for using near field communication (NFC) protocols, Bluetooth® protocols, Wi-Fi, Ultra-Wide Band (UWB), and other possible data connection and sharing techniques.

The TCU 104 may include wireless transmission and communication hardware that may be disposed in communication with one or more transceivers associated with telecommunications towers (e.g., cellular tower 140) and other wireless telecommunications infrastructure. For example, the BLEM 334 may be configured and/or programmed to receive messages from, and transmit messages to, one or more cellular towers 140 associated with a telecommunication provider, and/or and a Telematics Service Delivery Network (SDN) associated with the vehicle 100 for coordinating vehicle fleet.

The BLEM 334 may establish wireless communication using Bluetooth® and Bluetooth Low-Energy® communication protocols by broadcasting and/or listening for broadcasts of small advertising packets, and establishing connections with responsive devices that are configured according to embodiments described herein. For example, the BLEM 334 may include Generic Attribute Profile (GATT) device connectivity for client devices that respond to or initiate GATT commands and requests.

The RSU 110 and the TCU 104 may include radios configured to transmit (e.g., broadcast) and/or receive vehicle-to-everything (V2X) signals broadcast from another radio. Dedicated Short Range Communication (DSRC) is an implementation of a vehicle-to-everything (V2X) or a car-to-everything (CV2X) protocol. Any other suitable implementation of V2X/C2X may also be used. Other names are sometimes used, usually related to a Connected Vehicle program or the like.

The RSU 110 and the TCU 104 may include radio frequency (RF) hardware configured to transmit and/or receive signals, for example, using a 2.4/5.8 GHz frequency band.

Communication technologies described above, such as CV2X, may be combined with other technologies, such as Visual Light Communications (VLC), Cellular Communications, and short-range radar, facilitating the communication of position, speed, heading, relative position to other objects, and the exchange of information with other vehicles, mobile devices, RSUs, or external computer systems.

External servers (e.g., credit servers 130) may be communicatively coupled with the vehicle 100 and the RSU 110 via one or more network(s) 352, which may communicate via one or more wireless channel(s) 350. The wireless channel(s) 350 are depicted in FIG. 3 as communicating via the one or more network(s) 352.

The RSU 110 may be connected via direct communication (e.g., channel 354) with the vehicle 100 using near field communication (NFC) protocols, Bluetooth® protocols, Wi-Fi, Ultra-Wide Band (UWB), and other possible data connection and sharing techniques.

The network(s) 352 illustrate example communication infrastructure in which the connected devices discussed in various embodiments of this disclosure may communicate. The network(s) 352 may be and/or include the Internet, a private network, public network or other configuration that operates using any one or more known communication protocols such as, for example, transmission control protocol/Internet protocol (TCP/IP), Bluetooth®, Wi-Fi based on the Institute of Electrical and Electronics Engineers (IEEE) standard 802.11, WiMAX (IEEE 802.16m), Ultra-Wide Band (UWB), and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), Universal Mobile Telecommunications System (UMTS), Long Term Evolution (LTE), and the like.

The NAV system 330 may be configured and/or programmed to determine the vehicle location 150. The NAV system 330 may include a Global Positioning System (GPS) receiver configured or programmed to triangulate the vehicle location 150 relative to satellites or terrestrial based transmitter towers associated with the GPS 332. The NAV system 330 may determine and share the vehicle location 150 and receive locations such as the location of the RSU 110 and locations around the RSU 110 such as the mode location 194. The NAV system 330 may store in memory fixed locations such as the location of the RSU 110 and the mode location 194.

The NAV system 330 may be further configured or programmed to develop routes from a current vehicle location 150 to a selected destination (e.g., the location of the RSU 110 or the mode location 194), display a map and present directions to the selected destination, and determine an estimated time to travel to the selected location and a predicted time of arrival. The estimated time of arrival may be based on the position, speed, and heading or other vehicle information determined by the NAV system 330. The business computer 120 system may use such information from the NAV system 330 to predict when to prepare an order or a sequence of orders.

The system is also configured to determine the vehicle locations 150 of vehicles 100 in the area (e.g., geozone 152) via connections to the RSU 110. As described above, vehicles 100 can directly connect to the RSU 110. The RSU 110 can determine, for example, based on the strength of a direct connection, if the vehicle location 150 is in the geozone 152. The RSU 110 may also determine locations (or a relative locations) of the vehicle 100 based on signal strength.

The BCM 312 generally includes an integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 312 may also operate as a gateway for bus and network interfaces to interact with remote ECUs.

The BCM 312 may coordinate any one or more functions from a wide range of vehicle functionality, including energy management systems, alarms, vehicle immobilizers, driver and rider access authorization systems, Phone-as-a-Key (PaaK) systems, driver assistance systems, Autonomous Vehicle (AV) control systems, power windows, doors, actuators, and other functionality, etc. The BCM 312 may be configured for vehicle energy management, exterior lighting control, wiper functionality, power window and door functionality, heating ventilation and air conditioning systems, and driver integration systems. In other aspects, the BCM 312 may control auxiliary equipment functionality, and/or is responsible for integration of such functionality. In one aspect, a vehicle having a vehicle control system may integrate the system using, at least in part, the BCM 312. For example, the BCM 312 may be used to control vehicle systems according to the mode message 192.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation. All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A system, comprising:
a road-side unit associated with a business location; and
a vehicle control unit of a vehicle, the vehicle control unit comprising a human machine interface;
wherein the system is configured to:
generate, via the human machine interface, an order for goods and/or services;
send the order from the vehicle control unit to the road-side unit; and
generate an alert message to send to a business computer at the business location when a vehicle location of the vehicle is inside a geozone.

2. The system of claim 1, wherein the vehicle control unit is configured to send a request message including a vehicle identifier to authenticate the vehicle and confirm the order.

3. The system of claim 1, wherein the vehicle control unit is configured to generate a purchase message including a vehicle account to complete a transaction for the order.

4. The system of claim 1, wherein the vehicle control unit is configured to receive an advertisement message from the road-side unit.

5. The system of claim 1, wherein the alert message includes instructions to at least one of prepare the order and bring the order out to the vehicle.

6. The system of claim 5, wherein the system is configured to generate a status message and send the status message to the vehicle control unit to notify the vehicle of a status of the order.

7. The system of claim 5, wherein the business computer is configured to determine a sequence in which to at least one of prepare orders of multiple vehicles and bring orders out to the vehicles based on the sequence in which alert messages are received from different vehicles.

8. The system of claim 1, wherein the system is configured to send the vehicle location to the business computer.

9. The system of claim 8, wherein the business computer is configured to map the vehicle location.

10. The system of claim 8, wherein the business computer is configured to determine a sequence in which to at least one of prepare and deliver different orders based on the vehicle location associated with each of the orders.

11. The system of claim 10, wherein the sequence is based on a distance along a path.

12. The system of claim 1, wherein the system is configured to generate a mode message to instruct the vehicle control unit to place the vehicle in a mode of operation that controls one or more vehicle systems.

13. The system of claim 1, wherein the system is configured to provide the vehicle control unit with a mode location.

14. The system of claim 13, wherein the vehicle is configured to generate directions to the mode location.

15. The system of claim 13, wherein the vehicle control unit is configured to place systems of the vehicle in a mode of operation when the vehicle location matches the mode location.

16. The system of claim 1, wherein the geozone is defined by the road-side unit.

17. A system, comprising:
a road-side unit associated with a business location; and
a vehicle control unit of a vehicle, the vehicle control unit comprising a human machine interface;
wherein the system is configured to:
generate, via the human machine interface, an order for goods and/or services;
send the order from the vehicle control unit to the road-side unit; and
send a vehicle location to a business computer at the business location.

18. The system of claim 17, wherein the business computer is configured to coordinate operation of systems that communicate with or are controlled by the business computer based on the vehicle location.

19. The system of claim 18, wherein the business computer is configured to operate business systems that are associated with different zones as the vehicle location moves along a path through the zones.

20. The system of claim 17, wherein the system is configured to provide the vehicle control unit with a mode location.
